(19) United States
(12) Patent Application Publication
(10) Pub. No.: US 2005/0100779 A1
(43) Pub. Date: May 12, 2005

(54) Three dimensional polymeric fuel cell components

(76) Inventor: Michael Eric Gertner, San Francisco, CA (US)

Correspondence Address: Michael Eric Gertner, 971 Duncan Street, San Francisco, CA, 94131, US

(21) Appl. No.: 10/703,765

(22) Filed: Nov. 7, 2003

(51) Int. Cl. H01M 4/86; H01M 4/92; H01M 4/90

(52) U.S. Cl. 429/42; 429/40

(57) ABSTRACT

A fuel cell component is described wherein a porous polymeric substrate is coated with a first conductive coating and optionally a second and third coating to enhance catalysis activity.

### BACKGROUND

Invention relates to the general field of fuel cell materials. Fuel cells are poised to revolutionize the electric power industry. They derive power from the electrochemical oxidation of hydrogen and/or organic fuels. These cells are remarkably more efficient than power sources available today. Furthermore, their reactive byproducts are more environmentally friendly than current power sources. In the case of hydrogen, water is the only byproduct. In the case of methane, carbon dioxide is produced along with water.

The fundamental structural elements of fuel cells are the electrodes (anodic and cathodic), the electrolyte (either a membrane and/or a liquid) through which positive hydrogen ions travel, and the catalyst which facilitates the breakdown of the fuel into electrons and hydrogen ions. The following is the chain of events: fuel (e.g. methane) interacts with a catalyst (typically platinum or platinum/ruthenium) which generates a hydrogen ion and an electron. The electron passess through the conducting electrode and to the energy requiring load. Carbon dioxide is formed from the reduction of the methanol. The generated hydrogen ion passes through the conducting electrolyte fluid or membrane to the cathode side of the cell. Here, oxygen is prepared through interactions with the cathode catalyst. The hydrogen ion interacts with oxygen molecule and an electron to form a water molecule.

Fuel cells are in many instances produced by hand. Newer fuel cells being developed are manufactured through more automated tools from the semiconductor industry. As an example, WO 01/3757 and WO 03058734A1 (herein incorporated by reference) delineate a process by which silicon is etched to form a conductive mesoporous structure so that it can accommodate catalyst particles which are subsequently chemiabsorbed into the pores.

Despite a transition from hand-crafted fuel cells to microfabricated and more automated fuel cell components, the cost of fuel cells remains prohibitively high at this point. The challenge remains to produce a fuel cell which can produce electricity at a higher energy density than current power sources.

There are at least three areas in which fuel cell efficiency can be improved. The first is the electrode; mass transfer limits the amount of fuel that can reach the catalyst on the electrode side. Typical electrodes are two-dimensional in nature so that the fuel is limited to a linear concentration gradient toward the electrode. It is the interface between the electrode, the catalyst, and the fuel which needs to be maximized in order to improve efficiency. To maximize efficiency, an electrode and current collector are preferred to reside inside the fuel reservoir. The second area is the conductivity and related corrosion resistance of the electrode assembly. A third area for performance improvement is the leakage current which is the leakage of fuel from the anodic to the cathodic compartment where it is oxidized directly to water . . . in essence, a short circuit. The challenge is in optimizing these components while retaining low costs.

Nanotechnology involves the utilization of nanometer scale materials to achieve novel ends sometimes unattainable by conventional methods. Many nanotechnologies utilize the concept of self-assembly wherein materials and devices are manufactured through spontaneous processes under specified conditions. One such example is electroless deposition of metals. In contrast to electroplating, the surface to be plated in an electroless process does not have to be conductive and electrical energy is not applied to the surface. Rather, the surface catalyzes nucleation of the metallic film which deposits spontaneously on the surface. The costs involved in self-assembly are by definition limited to ingredient costs.

### SUMMARY OF INVENTION

In accordance with the needs and limitations of fuel cells presented above, the current invention is directed toward producing fuel cells produced from simple self-assembly processes intended to optimize the transfer of mass and energy in the fuel cell while keeping costs low.

In one embodiment, a fuel cell component is devised from the following: 1) a base structure is composed of a porous, three dimensional polymer; 2) an electrochemically derived conductive layer is used to render the polymeric structure conductive; 3) optionally, a second and third metallic deposition process further render the conductive structure optimally catalytic.

In other embodiments, the catalytic ability of the optional second and third layers is enhanced by depositing ruthenium nano-clusters on the surface of the conductive layer.

In other embodiments, the ruthenium nano-clusters are embedded in the surface layer by electrochemically depositing a metallic layer on top of the ruthenium nano-cluster layer.

In other embodiments, the ruthenium nanoclusters are embedded in the surface layer by depositing a polymeric substance on top of the nanoclusters.

In some embodiments, the base porous substrate is formed spontaneously from a polymer or a natural biopolymer matrix.

In some embodiments, a conductive layer is spontaneously formed by activating the porous structure to accept an electrodeposited thin film.

In some embodiments, the catalytic composite beads are deposited within the porous structure.

In other embodiments, the catalytic coating consists of platinum and ruthenium and is deposited in an electroless deposition process.

In other embodiments, the catalytic composite beads are rendered catalytic by depositing platinum and ruthenium on top of a non-catalytic particle.

### BRIEF DESCRIPTION OF THE DRAWINGS

FIG. 1 is a depiction of a porous structure.

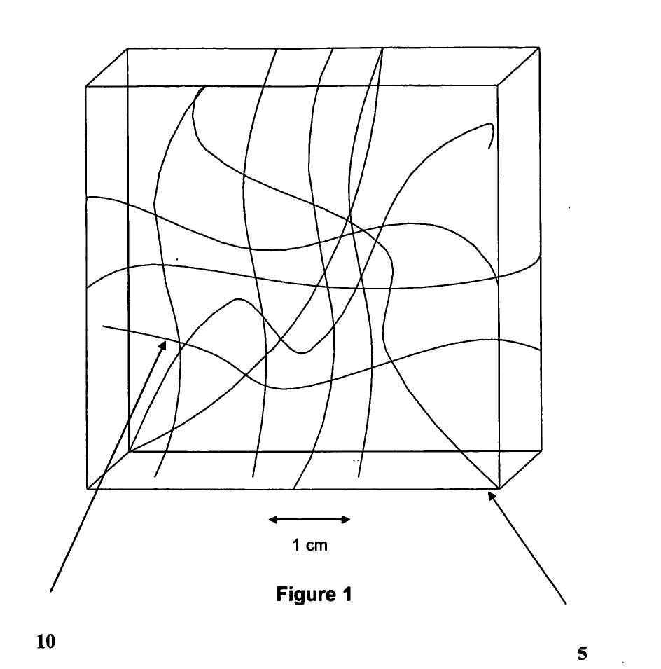

FIG. 2 is a depiction of a porous structure coated with a first conductive coating.

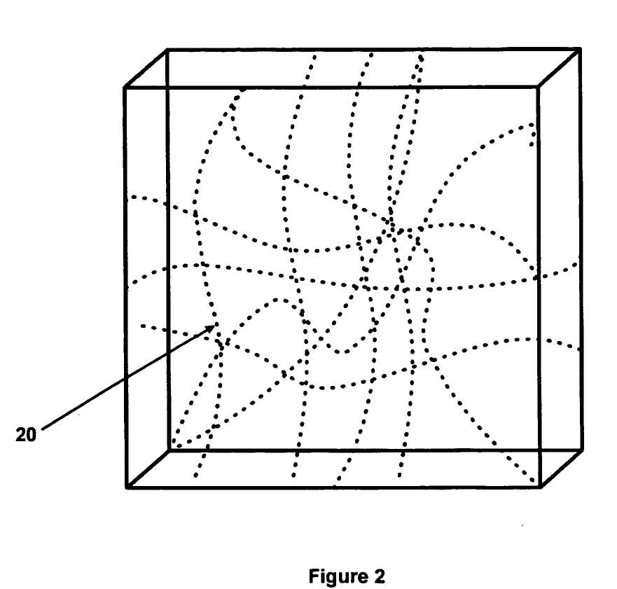

FIG. 3 is a cross section of one fiber of the porous substrate depicting a deposited conductive layer.

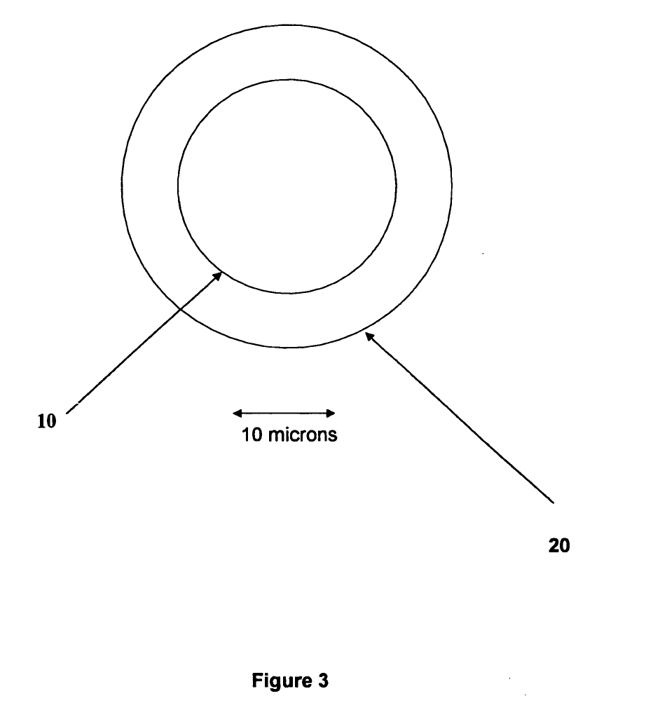

FIG. 4 is a cross section of the porous substrate with the optional second catalytic coating and the optional third catalysis enhancing layer.

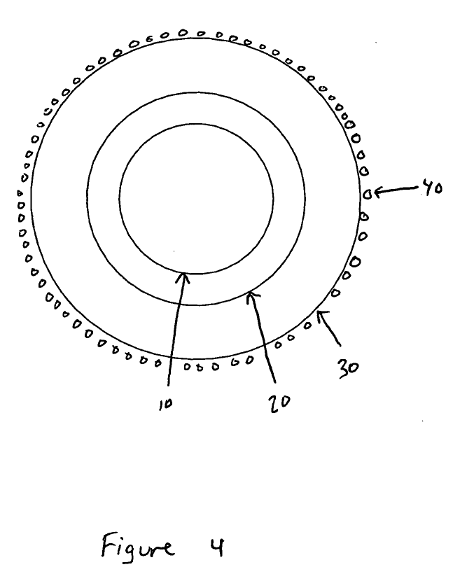

### DETAILED DESCRIPTION

Three Dimensional Self-Assembled Electrodes:

The base porous structure 10 is a representation of a polymeric three-dimensional structure. A self-assembled structure is one in which the structure is built from the bottom-up rather than starting with a raw material subsequently processed into a final form. Typically, the raw ingredients in a self-assembled structure are mixed together in an environment with controlled variables such as temperature, pH, atmosphere, etc. Thereafter, the structure forms spontaneously. One example of a self-assembled structure is a three-dimensional membrane made from a polymeric substance. Monomers are introduced into an aqueous bath conducive to polymerization, after which, the monomers polymerize into a structure. 5 denotes the edge of the structure which can easily be molded for compatability with a linear electrode.

The structure 10 is a highly porous one preferably with porosity greater than 90% but may also have a porosity from 30-89%. The porosity is potentially controllable depending on the amount of monomer and crosslinking agent utilized. The structure can be composed of a natural occurring polymer such as that made from amino acids, nucleic acids, or carbohydrates. It can also be composed of any of a variety of artificially produced polymers including but not limited to polytetrafluoroethylene, polypyrrole, polyaniline, polyester, etc. The porosity is designed intentionally for maximal interaction between fuel and the electrode.

The structure 10 can also be produced from nanostructured elements such as carbon nanotubes, buckyballs, or other nano-elements such as metal oxide nanoparticles. The elements can be functionalized with chemical moieties to allow for polymerization and/or crosslinking. The nanostructured elements can be conducting or semi-conducting as well.

After formation of the porous base structure, a conductive coating 20 is applied to the porous structure to substantially coat the entire surface area. It is a requirement that the conductive coating faithfully coat and reproduce the porous structure evenly and that the coating furthermore be robust and corrosion resistant. Furthermore, the coating process cannot harm the porous structure. Electroless deposition processes can satisfy many of these requirements as these processes generally occur in fluidic media and the coating is deposited on whatever the fluid contacts. Another advantage of electroless deposition processes is that they can be applied to non-conductive substrates such as polymers. A further advantage of electroless processes is that a very thin coating of metal (i.e. micron or sub-micron thickness) can be applied such that the porous structure is covered and the properties of the metallic film are realized yet the coating is thin enough so that the cost is minimal. Many electroless processes occur at temperatures less than 60 C and at atmospheric pressure so that the fragile porous substrate is not damaged. Another advantage is that the capital cost for electroless deposition equipment is very low providing for very economical manufacturing processes.

Examples of electroless coatings include but are not limited to platinum, gold, silver, nickel, cobalt, palladium, and copper, and many alloy combinations thereof. A property of electroless deposition is the ability to co-deposit secondary materials into the film. Co-deposition of material within the electroless film can enhance many of the desired properties of the metal film. For example, diamond nanoparticles incorporated into electroless nickel films increases their hardness. PTFE incorporated into nickel films can increase their lubricity. Co-deposition can also increase the catalytic properties of the films.

In some cases, the first electroless coating serves as a catalyst for the fuel in the fuel cell. This would be the case for a metal such as platinum and to a lesser extent gold. In other cases, a second (optional if the first coating is not catalytic enough) coating such as platinum 20 is deposited on top of a first gold coating. Not only are these noble metals important to catalysis but they are very good conductors and are highly corrosion resistant as well. In combination with the porous structure beneath, the electrode criteria mentioned above are satisfied and the interaction between electrode and fuel can be optimized. Again, when these metal are applied as a 1-2 micron thin film, they are quite inexpensive to produce.

In some cases, a catalytic enhancer such as, but not limited to ruthenium is incorporated into the catalytic layer or as its own (i.e. second catalytic) 30 film. There are many examples of methods to incorporate ruthenium into the catalytic profile of the metallic film. For example, ruthenium salts can be codeposited with the metallic anions. Ruthenium nanoparticles can also be incorporated into the film coating.

In a particularly preferred embodiment, a ruthenium salt solution is allowed to form nano-islands on the surface of the platinum or gold (Crown et. al. Surface Science 506 (2002) L268-L274. To better retain the ruthenium islands on the platinum or gold film, the ruthenium islands can be covered by another metallic film (trapping of the nanoislands) or a thin polymer coating (nano-island covering).

### EXAMPLE 1

### Polymer-Electroless Gold Catalytic Electrodes

Preparation of Chitin Hydrogels

Chitin is but one examples of a porous polymeric substance which can be used as the porous substrate in this invention. Chitosan is a natural occurring substance which forms the chitin hydrogel with a high degree of porosity. Chitosan solution is prepared by adding 5 grams of powder to 500 ml 0.1M acetic acid and allowing the mixture to stir at room temperature for approximately 6 hours. The monomer solution was then degassed over night under vacuum. To prepare a chitosan structure, the solution was poured into a chamber and the solvent allowed to evaporate. Afterward, the dried films were washed with distilled water. Next the films were placed in a 1:9 mixture bath of acetic anhydride:methanol to polymerize the chitosan to chitin. The films were then cryomilled into the desired shape after freezing in liquid nitrogen.

Application of Electroless Gold Coating:

In order for the gold to catalyze and adhere to the biopolymer a displacement reaction is required. An electroless nickel bath is first applied to the substrate followed by the electroless gold layer. To activate the polymer surface for electroless nickel, a solution containing 0.1 g/L PdCl, 1 g/L SnCl₂, 10 ml/L HCL is utilized. The polymer is dipped in this solution for approximately 2 minutes and then rinsed in deionized water. This is repeated several times so that the stannous solution.

Following activation of the surface of the porous polymer using a stannous/palladium solution, an aqueous solution of electroless nickel is prepared using any of several bath preparations. One bath which has been found to be particularly useful because of a low activation temperature contains 25 g/L NiSO₄, 23 g/L NaH₂PO₂, 9 g/L NaC₂H₃O₂. The pH is adjusted to approximately 5-6 and the reaction proceeds quickly at 50 C and at 40 C, albeit more slowly. Because the electroless nickel is a displacement layer, a thickness of much less than a micron is needed which occurs in less than 10 minutes at 40 C.

An electroless gold coating is then applied to the chitin-nickel hydrogel. An aqueous bath containing 0.03M Na₃Au(S₂O₃)₂, 0.05M Na L-ascorbate, and 4M Citric acid: pH (KOH) 6.4, Temp. 30 C. The plating rate is approximately 1 micron per hour with this bath; by 1 hour, the coating was continuous at approximately 2-3 microns.

Ideally, to enhance the catalytic activity of the gold, a second catalytic layer is applied to the gold coated porous structure; this layer is also deposited by a self-assembly process such as electroless deposition. Typically, this layer would be a platinum catalyst as is used in most fuel cells. A combination of platinum and ruthenium has been found to be more preferable than platinum alone; with this combination, platinum is less susceptible to poisoning by carbon monoxide when the ruthenium is present.

A typical electroless platinum plating bath contains: Na₂Pt(OH)₆ 10 g/L; NaOH, 5 g/L, C₂H₈N₂ 10 g/L, and N₂H₄ at a temperature of 35 C and a typical deposition rate of 12.7 microns/hr. The electroless plating bath is allow to diffuse into the hydrogel and deposit on top of the gold 30. Due to the catalytic nature of the gold, the electroless platinum autocatalytically deposits on the gold layer.

Ruthenium salts (RuCl₃) have been shown to spontaneously deposit on platinum (Crown et. al. Surface Science 506 (2002) L268-L274 herein incorporated by reference). These deposits do not form continuous layers as in a typical electroless process; however, nanometer sized islands are formed on the platinum 40. Such islands have been shown to improve the catalytic efficiency of platinum as related to methanol oxidation.

1. A catalytic fuel cell component comprising:
a. a porous polymeric material
b. a first electrochemically deposited conductive coating
c. an optional second electrochemically deposited conductive and catalytic coating
d. an optional third electrochemically deposited, catalysis enhancing coating

2. The fuel cell electrode of 1 wherein said polymeric material is a biologic polymer.

3. The fuel cell electrode of 1 wherein said polymeric material is a hydrogel.

4. The fuel cell electrode of 1 wherein said polymeric material is derived from nanostructured elements.

5. The fuel cell electrode of 1 wherein said first coating is electrochemically deposited gold.

6. The fuel cell electrode of 1 wherein said first coating is electrochemically deposited platinum.

7. The fuel cell electrode of 1 wherein said first coating is derived from nanostructured elements.

8. The fuel cell component of 1 wherein said second catalytic coating is electrochemically deposited platinum.

9. The fuel cell component of 1 wherein said optional third catalysis enhancing component are ruthenium nanoclusters

10. The fuel cell electrode of 1 wherein said second catalytic coating is non-continuous and comprised of particles larger than 500 nanometers.

11. The fuel cell component of 10 wherein said catalytic particles comprise a first material and a second material.

12. The fuel cell component in 11 wherein said first material in said catalytic particles has a particle structure

13. The fuel cell component in 11 wherein said second material in said catalytic particles is an electrochemically deposited catalytic coating.
